(19) United States
(12) Patent Application Publication
(10) Pub. No.: US 2010/0119074 A1
(43) Pub. Date: May 13, 2010

(54) DEVICE AND METHOD FOR EVALUATING THE SOUND EXPOSURE OF AN INDIVIDUAL

(76) Inventor: Frederic Louis Christian Devinant, Lyon (FR)

Correspondence Address: DOWELL & DOWELL P.C., 103 Oronoco St., Suite 220, Alexandria, VA, 22314, US

(21) Appl. No.: 12/449,167

(22) PCT Filed: Feb. 5, 2008
(86) PCT No.: PCT/FR2008/000133

§ 371 Date: Jul. 27, 2009

(30) Foreign Application Priority Data
Feb. 6, 2007 (FR) 07 00829

(51) Int. Cl. H04R 29/00

(52) U.S. Cl. 381/56

(57) ABSTRACT

The invention relates to a device for evaluating the sound exposure of an individual (2) staying in at least one noisy location (L1), characterised in that it comprises: at least one means for determining the moments of entry (31) and exit (32) of the individual (2) respectively into and out of said location (L1); at least one sensor (4) provided in the location (L1) for carrying out noise measurements; and a calculator (5) capable of communicating with the or each determination means on the one hand, and of communicating with one or each sensor (4) on the other hand, and capable of defining values representative of the sound exposure of the individual during his stay, the calculator (5) being capable of emitting signals representative of this sound exposure.

The invention relates to a device and a method for evaluating the sound exposure of an individual spending time in one or more location(s) exposed to the noise emitted by at least one source. The subject of the invention makes it possible to reduce the auditory risks caused by the accumulation of many sound exposures of the individual during his work and/or leisure activities.

In a known manner, such an accumulation, produced over a continuous or fractioned period, may lead to a sound overexposure of the individual and, consequently, to auditory problems, and even pathologies.

To evaluate the sound exposure of an individual, there are individual or collective devices capable of making noise measurements and of integrating these measurements over the exposure time. In the rest of the description, “sound” and “noise” are used without distinction.

A collective device measures the instantaneous noise level and consolidates it in order to evaluate the equivalent average sound level L_{eq} (“level equivalent”) or L_{avg} (“level average”). Such a device may also measure the peak pressure level Lpc (“level peak”) or Lₘₐₓ (“level maximum”) of the sound over a period. However, a collective device by definition cannot take account of the sound exposure of an individual spending time in the location in which the noise measurement is taken, because it is not informed, on the one hand, of the time spent by the individual in the noisy location outside which the risk of overexposure disappears and, on the other hand, of the position of this individual relative to the sound source(s), which renders the measurement insufficiently accurate. Finally, it is not able to measure the exposure of individuals spending time in the noisy location in a non concomitant manner.

Furthermore, individual portable devices are known of the noise dosimeter type, such as that described by U.S. Pat. No. 3,802,535. Such a portable dosimeter usually comprises a sonometer-integrator measuring the ambient noise to which the individual is exposed, and being able to integrate this noise measurement on the basis of the time spent by the individual, thereby supplying a precise measurement of his sound exposure, or sound dose. However, a noise dosimeter is relatively costly, bulky and ungainly, because it must be worn by each individual in the vicinity of his ears. Moreover, such a noise dosimeter must be electrically supplied by accumulators, which represent a not inconsiderable weight and risk of failure. Furthermore, such a dosimeter is relatively fragile and must be regularly recalibrated in order to supply an accurate and reliable measurement of the sound exposure of the individual wearing it. In addition to the requirement imposed by such a recalibration, the individual device can easily be compromised, causing an incorrect evaluation of the individual sound exposure.

These disadvantages prevent the widespread use of these individual devices for protecting all the people who go to a discotheque, a concert hall, a factory or any other noisy location.

The object of the present invention is notably to remedy these disadvantages by proposing a device and a method for evaluating the sound exposure of an individual making precise and reliable measurements, taking account of the individual exposure time and not requiring a bulky and costly object to be worn by this individual. “Evaluate” means determining or quantifying a value.

Accordingly, the invention relates to a device for evaluating the sound exposure of an individual spending time in at least one location exposed to the noise emitted by at least one source, characterized in that it comprises:
at least one means for determining the moments of entry and of exit of the individual respectively into and out of the location;
at least one sensor installed in the location and capable of making noise measurements in at least one point of the location; and
a calculator capable, on the one hand, of communicating with the or each determination means and of defining the length of time spent by the individual in the location between the moments of entry and of exit and, on the other hand, of communicating with the or each sensor and of defining the values representative of the sound exposure of the individual during the time spent, the calculator being capable of emitting signals representative of this sound exposure.

In other words, no sensor or dosimeter has to be worn by an individual, because the sensor remains in the noisy location from which it transmits its measurements to the calculator, itself being able to be fixed in this location, in order to evaluate the sound exposure on the basis of the time spent by the individual in the noisy location.

According to other advantageous features of the invention:
the device also comprises an interface capable of receiving the signals and of informing the individual of his sound exposure;
the or each determination means comprises a member for recognizing the individual;
the or each determination means comprises a member for recognizing an object worn by the individual;
the or each determination means comprises an apparatus capable of detecting by radio identification a radio tag worn by the individual;
the calculator is capable of communicating with means for locating the individual in real time in the location and of weighting the noise measurements according to the position of the individual relative to the sound source or sources;
the location means comprise several items of apparatus spread out in the location and delimiting elementary spaces, the items of apparatus being capable of detecting the movements of the individual between the elementary spaces;
the device comprises several sensors spread out in the location at the rate of at least one per elementary space, the calculator integrating the measurements made by the sensors installed in the elementary spaces consecutively traversed by the individual;
the device comprises means for signaling to the calculator the use by the individual of an individual sound protection means, notably of the headphone or earplug type;
the device also comprises a central calculator capable of communicating with the calculators installed in several locations and of totaling the sound exposures of the individual during consecutive or inconsecutive times spent in the various locations, the central calculator being capable of applying corrections according to the physiological recovery times separating the times spent and/or according to the medical antecedents of the individual;
the device comprises means of communication, to the calculator or to the central calculator, of the sound exposure received by the individual when he is exposed to the sound emitted by a personal listening means, notably a personal stereo player fitted with a headphone or an earphone;
the device comprises means of communication, to the calculator or to the central calculator, of the sound exposure measured by a personal dosimeter worn by the individual.

The invention also relates to a method that can be used with a device as described above in order to evaluate the sound exposure of an individual spending time in at least one location exposed to the noise emitted by at least one source. This method comprises steps consisting in:

a) making noise measurements in at least one point of the location by means of at least one sensor;'

b) determining the moment of entry of the individual into the location;

c) communicating the moment of entry to a calculator;

d) communicating the noise measurements to the calculator;

e) integrating the noise measurements over the time spent by the individual in the location between the moments of entry and of exit by means of the sensor(s) or of the calculator;

f) determining the moment of exit of the individual from the location;

g) emitting signals representative of the sound exposure of the individual during the time spent.

According to the variants of the method, the step f) precedes the step g) or else the step g) precedes the step f).

This method may also comprise the steps consisting in:

m) computing the physiological recovery time necessary to reduce the dose of noise received by the individual during his sound exposure to the level of a predetermined value;

n) emitting signals representative of said physiological recovery time.

Advantageously, this method may also comprise a step h) consisting in transmitting the signals emitted during the step g) and/or during the step n) to an interface at the request of the individual and/or at any moment predefined in the calculator and/or when his sound exposure exceeds or reaches a predetermined value, notably as a function of a normative threshold.

The order of the steps e), f), g), m), n) and h) may be modified in the context of the present invention.

This method may also comprise prior steps consisting in:

i) making noise measurements at several points spread out in the location and at a distance from the source;

j) defining a correction of the noise measurements received at each of the points;
and steps consisting in:

k) locating the individual in real time in this location;

l) weighting values representative of the noise measurements of the sensor as a function of the corrections of the location.

The invention will be well understood and other advantages of the latter will also appear in the light of the following description of several devices according to the invention, given only as an example and made with reference to the appended drawings in which:

FIG. 1 is a schematic representation of a device according to a first embodiment of the invention;

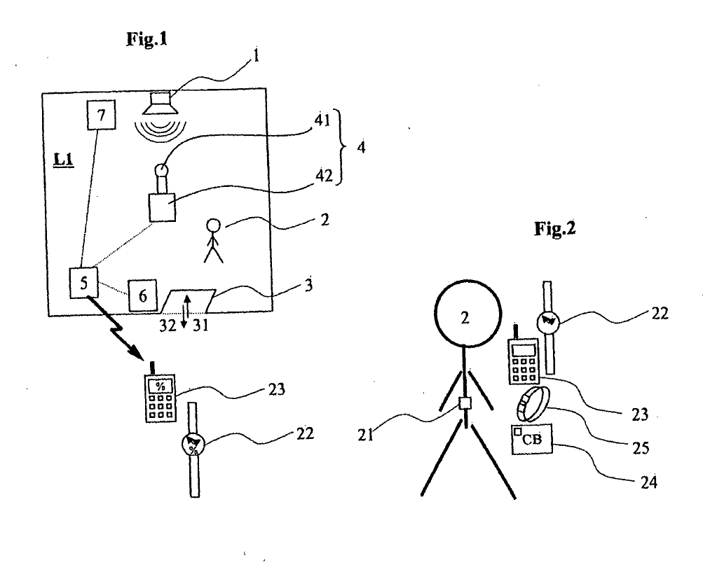

FIG. 2 is a schematic representation of an individual and of several variants of components of a device according to the invention;

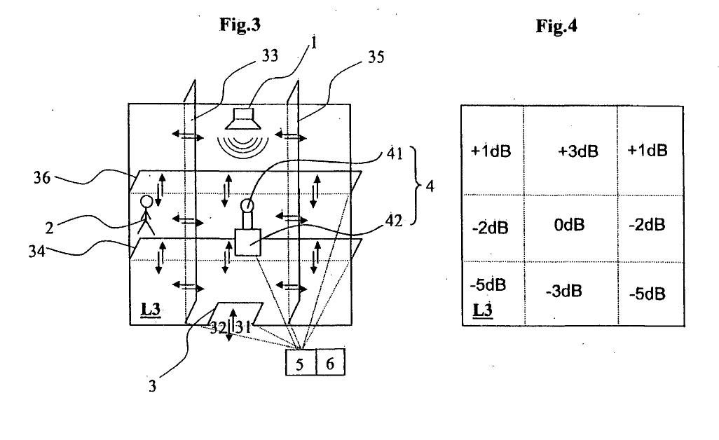

FIG. 3 is a schematic representation of a device according to a second embodiment of the invention;

FIG. 4 is a schematic representation of a noisy location illustrating a step of a method according to the invention;

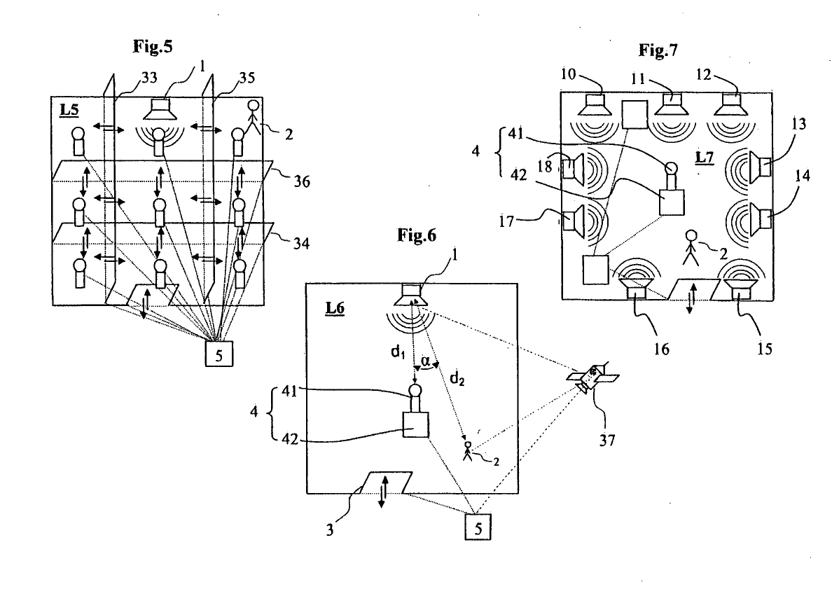

FIG. 5 illustrates a variant of the device of FIG. 3 which forms a third embodiment of the invention;

FIG. 6 is a schematic representation of a device according to a fourth embodiment of the invention;

FIG. 7 is a schematic representation of a device according to a fifth embodiment of the invention;

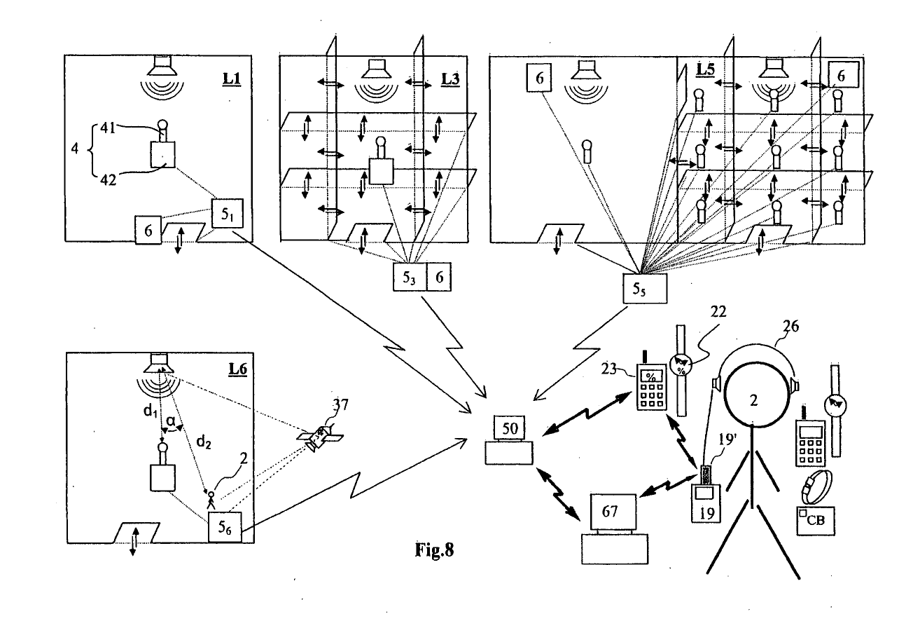

FIG. 8 is a schematic representation of a device assembling devices illustrated in FIGS. 1, 3, 5 and 6;

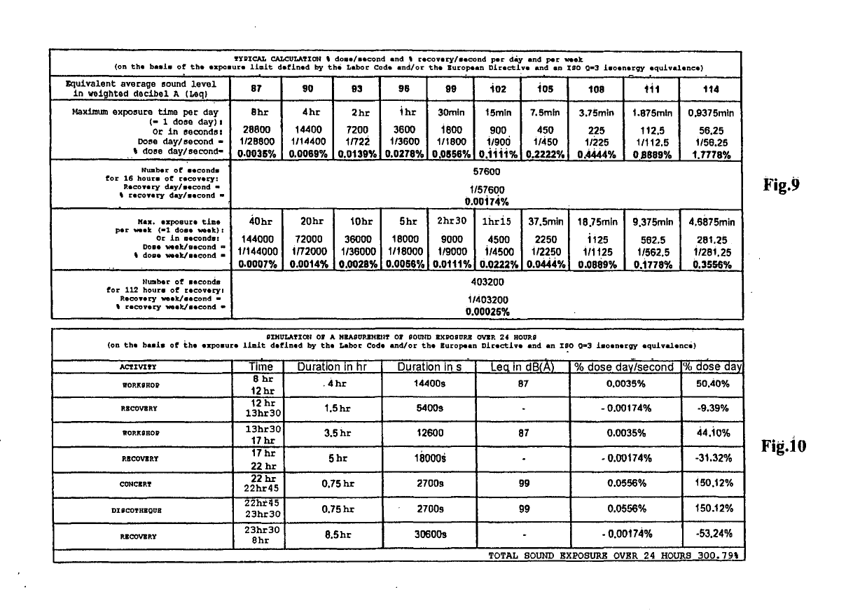

FIG. 9 represents a table exemplifying a computation of sound exposures;

FIG. 10 represents an example of simulating an individual sound exposure.

FIG. 1 shows a location L₁ exposed to the noise emitted by a sound source 1. “Location” means any space liable to have a noisy environment. In this instance, the location L₁ may consist of industrial premises or a concert hall or discotheque. “Source of noise” means any apparatus capable of emitting sounds or noises. It may for example be a loudspeaker or an industrial machine.

The location L₁ is capable of accommodating one or more individuals for whom it is desirable to manage the risk of auditory problems. In order to know precisely the moments of entry and of exit of an individual 2 respectively into and out of the location L₁, the latter is fitted with an appropriate determination means situated close to an access to the location L₁.

The determination means comprises a recognition member formed in this instance by a radio-identification gate 3 operating according to the Radio Frequency Identification (“RFID”) technology. To allow him to be identified by the gate 3, an individual 2 wears an object which is specific to him and which is capable of interacting with the recognition member belonging to the determination means of the location L₁. In this instance, as shown in FIG. 2, the individual 2 wears a radio tag 21 capable of being activated by the gate 3 and of thereby transmitting to him the information that it contains. This information, which may be of any kind, is intended to identify the individual 2 unequivocally when he enters and leaves the location L₁, the entrances and exits being symbolized respectively by the arrows 31 and 32 in FIG. 1 which show respectively the moments of entry into and exit from the location L₁.

As an alternative to the gate 3, the means for determining the moments of entry 31 and of exit 32 of the device may comprise a member for recognition of the individual 2 or of an item of information associated with the individual 2. Amongst the examples of such a recognition member, it is possible to cite a speech recognition member, a digital recognition member or else a numerical keypad on which the individual 2 enters a personal code. These recognition members have the advantage of not requiring any specific object to be worn by the individual 2.

The individual's recognition member may furthermore consist of a pre-existing identification apparatus, such as those interacting with a social security card, a bank card, a watch with a transceiver or a cell phone.

Whether it be by the gate 3 or by one of the other items of equipment envisaged above, a specific identification number is associated with each individual 2.

The device of FIG. 1 also comprises a local calculator 5 capable of communicating with the gate 3 in order to record the moments of entry 31 and of exit 32 of the individual 2 into and out of the location L₁. The calculator 5 may consist of a computer or of any other data-management member. It may be in the location L₁, as shown in FIG. 1 or be at a distance from it while remaining connected to the various components of the device that is the subject of the invention via electronic communication means.

The radio tag 21 may be incorporated into or attached by any attachment means to a personal object of the individual 2, such as his watch 22, his cell phone 23, a personal magnetic card 24 or else a bracelet 25 supplied, for example, by the authority controlling the location L₁ prior to entry 31. In practice, the radio frequency identification may be operated by the gate 3, but also by a terminal or by any similar electronic reader.

Installed in the location L₁ is a sensor 4 capable of measuring the noise at one or more points in the location L₁. In this instance, the sensor 4 is installed substantially in the center of the location L₁. In practice, the sensor 4 consists of an integrator sound-level meter installed in the portion of the location L₁, where the measurement made is the most representative of the sound levels perceived by the individuals present in this location. The sensor 4 has an integrator module 42 which is capable of supplying the equivalent average sound level, perceived by a microphone 41 belonging to the sensor 4, over a short period, for example of the order of a second, thereby defining a unitary exposure value. The sensor 4 is also capable of determining the peak pressure level over a given period. The average equivalent sound level may therefore be supplemented by the number of times an acceptable maximum peak pressure level is exceeded in order to define with accuracy the sound exposure of an individual 2 present in the location L₁. The sensor 4 therefore produces an integrator sound-level meter for noise which may also apply a physiological weighting, for example of type A, B or C, to the measurements that it makes.

The calculator 5 is capable of communicating with the sensor 4 via wire or radio means not shown. The calculator 5 therefore receives from the sensor 4 signals representative of the unitary exposure values relating to the noise emitted by the source 1. Since it is informed by the gate 3 of the entrances 31 and exits 32 of the individual 2, it may total together the unitary exposure values transmitted by the sensor 4 over the total time spent, that is to say integrate the result of the noise measurements over the time spent.

The result of this totaling corresponds to the sound exposure of the individual 2 during the time he spends in the location L₁.

In a yet more detailed manner: the module 42 integrates the noise level perceived by the microphone 41 over short periods, for example of one second, or one minute, depending on the accuracy sought and the calculation processing power the user has. The integrated unitary exposure values over these short periods are transmitted by the sensor 4 to the calculator 5. They are then the subject of totaling over the time spent by each individual 2 in order to determine the dose of noise that he receives during his stay. In practice, the totaling is carried out by the calculator 5 at the end of each short period, which makes it possible to determine, virtually in real time, the dose of noise received. The dose of noise of each individual 2 is then associated with his electronic identity number by the calculator 5.

According to a variant of the invention, the output signal from the microphone 41 may be transmitted directly to the calculator 5 which itself integrates it over a short period. In this case, the module 42 is dispensed with and the definition and the processing of the values representative of the sound exposure take place only in the calculator 5.

The sensor 4 and the calculator 5 therefore produce a noise dosimeter capable of associating with an electronic identity number of each individual 2, a value representative of his sound exposure during the time he spends in a noisy location in which he has been identified by the determination means 3.

In addition, the calculator 5 is capable of emitting signals representative of the sound exposure of the individual 2 during his stay between the moments 31 and 32 in the location L₁.

The device of FIG. 1 also comprises an interface 6 capable of receiving such a signal emitted by the calculator 5, then of informing the individual 2 of his sound exposure. The interface 6 may consist of a distributor situated close to the exit from the location L₁ and beyond the gate 3 and supplying the individual 2 with a ticket specifying his sound exposure.

Alternatively, the interface may consist of a digital display screen and optionally supplemented by a readout 7 situated in the location L₁ in order to indicate in real time to the individual 2 his sound exposure. Again alternatively, the interface may consist of the watch with transceiver 22 or of the cell phone 23 of the individual 2 to which the calculator 5 sends an alphanumeric or figurative message representing his sound exposure. Similarly, the watch 22 or the cell phone 23 may incorporate a member performing some or all of the functions of the calculator 5.

The calculator 5 may also take account of the individual's use of an individual sound protection means of the headphone or earplug type. When the protection means or its storage case is fitted with a switch emitting a signal to the calculator 5, the latter knows precisely the moment from which the individual is wearing the sound protection means. This switch-emitter then forms a means for signaling to the calculator 5 the individual's use of the protection means. The calculator 5 then weights the noise measurements so as to take account of this protection and to supply a precise evaluation of the sound exposure of each identified individual.

FIGS. 3 and 4 show a variant of the device of FIG. 1, in which the calculator 5 is capable of communicating with the real-time location means of the individual 2 in a location L₃. The location means, in this instance, consist of radio identification gates 33 to 36 similar to the gate 3 detecting the entrance 31 and exit 32 of individual 2 in the location L₃.

The gates 33 to 36 are distributed in the location L₃ so as to divide it into elementary spaces symbolized by the dotted lines in FIGS. 3 and 4. The gates 33 and 36 may therefore detect by radio identification the movements of the individual 2 between the elementary spaces. These movements are symbolized in FIG. 2 by arrows similar to the arrows 31 and 32. The calculator 5 then has a real-time indication of the positioning of the individual 2 in the noisy location.

In a method according to the invention, the user carries out, prior to the individual 2 entering the location L₃, an acoustic calibration of the location L₃, based on noise measurements taken at several points at a distance from the source 1 and distributed throughout the location L₃ so as to represent each elementary space. These measurements make it possible to define a correction to the noise received 2 5 for each of the elementary spaces.

In this way, a chart is established of the corrections to be applied to the noise measurements depending upon the elementary space occupied by the individual 2. FIG. 4 shows such a chart indicating the corrections in decibels with reference to the central elementary space of the location L₃ containing the microphone 41. Therefore, the correction in this instance is +3 dB for the elementary space containing the source 1, while it is −5 dB for the elementary spaces furthest from the source 1.

Because of this chart of the corrections to be applied and of the real-time location of the individual 2 by the gates 33 to 36, the calculator 5 is capable of weighting the noise measurements according to the position of the individual 2 in the noisy location or, more precisely, according to the elementary space containing him. The device of FIG. 3 therefore supplies an evaluation of the sound exposure of the individual 2 that is more accurate than that of the device of FIG. 1, because it is capable of following the movements of the individual 2, and of taking account of the differences in sound levels that may exist in the location.

FIG. 5 illustrates a variant of the device of FIG. 3, in which each elementary space of a location L₅ comprises at least one microphone 41. The calculator 5 therefore has real-time noise measurements made in each elementary space. It is therefore not necessary to produce a prior chart of the corrections to be applied to the noise measurements. In addition, the calculator 5 is informed of the movements of the individual 2 between elementary spaces by means of the radio identification gates 33 to 36.

The calculator 5 is therefore capable of integrating the measurement made by the microphone 41 corresponding to the elementary space actually containing the individual 2. The device of FIG. 5 therefore supplies an accurate evaluation of the sound exposure of the individual 2.

FIG. 6 shows another embodiment of the device that is the subject of the invention, in which the means for real-time location of the individual 2 in a location L₆ use a global positioning system comprising at least one satellite 37, or any geographic localization device. The individual 2, the sound source 1 and the microphone 41 of the sensor 4 are each fitted with an emitter allowing the satellite 37 to locate them accurately relative to one another.

The satellite 37 communicates to the calculator 5 the respective positions of the individual 2, the microphone 41 and the source 1, which may be designed to be movable. The calculator 5 can therefore determine the distance d₁ separating the source 1 from the microphone 41 and the distance d₂ separating the source 1 from the individual 2. Based on these data, the calculator 5 can weight the measurements made by the sensor 4 according to the variation of the distance d₂. Advantageously, the calculator 5 can determine and take account of the angle α between the axis of sound diffusion of the source 1 and the axis of positioning of the individual 2 relative to the source 1. Again advantageously, an acoustic calibration of a grid of elementary spaces can be carried out as explained above with reference to FIGS. 3 and 4, this calibration allowing the calculator 5 to weight the measurements made by the sensor 4 according to the positioning values of the individual 2 supplied by the satellite 37 and relative to this division into elementary spaces.

The device illustrated by FIG. 6 therefore supplies an accurate evaluation of the sound exposure of the individual 2. Such a device finds an advantageous application in the case of a location L₆ of extensive surface area. It is for example the case with open-air concerts, such as those put on in a festival.

The localization of an individual in a noisy location is however not necessary when the sound level prevailing therein is substantially uniform. Therefore, in the example of FIG. 7, a location L₇ is fitted with several sound sources 10 to 18 distributed on its periphery. In addition, the location L₇ can undergo an acoustic treatment such as the installation of special absorbent or reflective materials on its walls in order to make the sound level prevailing therein uniform. The sensor 4 therefore supplies noise measurements representative of the sound level to which an individual 2 is exposed irrespective of the position of the latter in the location L₇.

A situation similar to that mentioned with reference to FIG. 7 also occurs in the case of a sound source having a uniform wave front of the cylindrical type.

The devices illustrated by FIGS. 1 and 3 to 7 make it possible to evaluate the sound exposure of an individual spending time in a predetermined noisy location. However, the individual may, for a given period of time, frequent several noisy locations with rest phases between each stay.

FIG. 8 illustrates a device according to the present invention which makes it possible to add together the sound exposures of an individual 2 having spent time consecutively or not in the locations L₁, L₃, L₅ and L₆ fitted with devices described with reference to the relevant figures. As shown in FIG. 8, the location L₅ may also be next to a location similar to the location L₁. Other combinations of locations can of course be envisaged. In addition, the locations shown in FIG. 8 are not necessarily discotheques or concert halls, but may be any place of work, place of sports activities, vehicles, or any noisy location fitted with means like those described above.

The device of FIG. 8 also comprises a central calculator 50 capable of communicating with the local calculators 5₁, 5₃, 5₅ and 5₆ with which the locations L₁, L₃, L₅ and L₆ respectively are equipped. The central calculator 50 is capable of adding together the sound exposures of the individual 2 during his consecutive or inconsecutive stays in the various noisy locations. The calculator 50 may also take account of the sound exposure received by the individual 2 when he is exposed to the sound emitted by an individual listening means 19, such as a personal stereo player comprising a headphone or earphone 26, to the extent that this individual listening means is capable of communicating the electronic identification number of the individual 2, the duration, the listening sound level and/or the sound exposure values to the central calculator 50, optionally via the local calculator 5, by means of an appropriate emitter 19′ and/or via personal interfaces, such as his watch with a transceiver 22 or his cell phone 23 or a laptop computer 67. Similarly, the calculator 50 may take account of the sound exposure measured by an individual dosimeter (not shown) worn by the individual 2, to the extent that this individual dosimeter is capable of communicating the electronic identification number of the individual 2, the period of the measurement and the measured sound exposure values to the central calculator 50, optionally via the local calculator 5, by means of an appropriate data transmission device (not shown).

The device of FIG. 8 therefore makes it possible to evaluate the global sound exposure of the individual 2. Moreover, the central calculator 50 can apply to this global exposure corrections associated with the physiological recovery times separating the times spent in noisy locations, and with the medical antecedents of the individual 2. To take account of the physiological recovery phases between two stays of the individual in a noisy location, the global sound exposure may also, according to a variant, be expressed over a sliding period, that is to say actually calculated in real time for a given period up to the moment when its value is transmitted to the user's information interface.

The central calculator 50 may consist of a computer connected via a network of the intranet or internet type to the local calculators 5₁, 5₃, 5₅ and 5₆. The central calculator 50 may also communicate signals representative of the global sound exposure of the individual 2 to an interface consisting of the laptop computer 67, the watch with transceiver 22 or the cell phone 23 of this individual. For the personal interfaces 67, 22 or 23 as for the local interfaces 6, the central calculator 50 or the local calculators may transmit the signals indicating the sound exposure when the individual leaves a noisy location, when he requests it or when his global sound exposure exceeds or reaches a value determined by the individual himself or by a normative threshold. In addition to a laptop computer, a watch with transceiver or a cell phone, the interface may consist of various items of apparatus such as a screen, a readout, a vibrator, a flash generator, an alarm, a meter, a distributor of tickets or of electronic messages etc.

As a variant, the personal interface of the individual 2, such as his watch with transceiver 22 or his cell phone 23, may form an “individual” central calculator 50, which is then capable of receiving and managing directly the information on the sound exposure transmitted by the local calculators 5₁, 5₃, 5₅ and 5₆ and/or by the individual listening means 19.

The sound exposure of an individual may also be communicated, as required, to an authority that is responsible for or mindful of his health, such as his employer or a public health organization.

The sound exposure transmitted to the individual may be accompanied by information of an educational, normative or even coercive type when it is necessary to order the individual to leave particularly noisy premises. The sound exposure may also be transmitted to an item of apparatus capable of limiting the access of the individual to the noisy location, such as an automated door or any device making it possible to inform him of the need to wear ear protection, or even to issue them to him. The normative information may consist in reducing the sound exposure to an acceptable dose expressed by a standard such as, for example, the European ISO or American OSHA standards. This maximum admissible dose of noise may be indicated for a programmable period p which may be, for example, eight hours, one day, one week, one year, and even a professional career of 40 years.

In the rest of this description, the variable “p” added to the value of a magnitude corresponds to the length of the period for which this magnitude is considered. For example, the value “%dose,p” corresponds to a percentage dose, the value 100% being equal to the maximum dose that can be received, according to the reference standard, for the period p in question.

A method making it possible to evaluate the sound exposure of an individual 2 with respect to an acceptable dose over a period p is as follows:

Each individual has an “exposure account” managed by the central calculator 50, which he can query at any time, or the value of which can be transmitted to him regularly, when a programmable threshold is reached or exceeded or on entry into or exit from a noisy location equipped with a device according to the invention.

For each device installed and during each unitary period t, which may, for example, be a second, or a minute, or 10 minutes, the sensor 4 measures the equivalent average sound level (L_{eq},t) optionally physiologically weighted (filters A, B, C etc) and transmits its value to the calculator 5. By applying an optional “elementary space” or medical antecedents or else “protector wearing” weighting, the calculator 5 of each location associates the value of L_{eq},t to each electronic identity number identified in the location, corresponding therefore to the individuals 2 who are present. This calculator transmits all this information to the central calculator 50.

The central calculator 50 mathematically converts each L_{eq},t received into the %dose,p, then adds it to the exposure account corresponding to the specific electronic identification number with which it is associated.

At the same time, the central calculator 50 deducts a %recovery,p from each exposure account of the electronic identities that have not had an L_{eq},t added, that is to say of each account corresponding to an individual 2 who is in none of the noisy locations equipped with a device according to the invention, up to the possible limit of zero%dose,p.

The new values of the exposure accounts of each individual 2 may then be the subject, by the calculator, of any transmission for an informative, educational or coercive purpose.

The emission of the signals representative of the sound exposure of an individual during his stay precedes the determination of the moment when he leaves the noisy location. However, as a variant, it is possible first to determine the moment when the individual leaves this location, then to emit these signals.

Therefore, with respect to each exposure account corresponding to the identification numbers allocated as mentioned above, a cycle formed of the following steps is installed:
entry of the individual 2 into a location equipped according to the invention: the central calculator 50 begins to add the %dose,p obtained from the L_{eq},t supplied by the calculator 5 of this location;
exit of the individual 2 from the location equipped according to the invention: the central calculator 50 stops adding the %dose,p obtained from the L_{eq},t supplied by the calculator 5 of this location and begins to deduct a %recovery, p;
the individual 2 reenters the location equipped according to the invention, which may be the same location as the previous one or a new one: the central calculator 50 stops deducting the %recovery,p and restarts adding the %dose,p obtained from the L_{eq},t supplied by the calculator 5 of this location;
the cycle may continue indefinitely alternating in this way.

A variant to this method may consist in not deducting the %recovery,p and in totaling the %dose,p over a sliding period, that is to say in fact calculated in real time, for a given period up to the moment when its value is transmitted to the user's information interface. The exposure account can be reset to zero if necessary by the user with the central calculator 50 and via personal interfaces 22, 23 or a personal computer 67.

In addition, when the individual uses an individual listening means 19 fitted with an emitter 19′, an equivalent average sound level L_{eq}, measured by a sound exposure measurement device of the headphone 26, the corresponding period s of sound exposure and an electronic identification number are transmitted, in real time or after the fact, to the central calculator 50, if necessary via the local calculator 5. The central calculator 50 then mathematically converts the exposure value L_{eq},s received into %dose,p then adds it to the exposure account of the electronic identification number with which it is associated. If necessary, the central calculator 50 deducts from the exposure account in question a value of %reovery,p corresponding to the value of the period s transmitted.

Finally, when the individual 2 wears an individual dosimeter fitted with an appropriate data transmission device (not shown), an equivalent average sound level value L_{eq}, the corresponding period s of sound exposure and an electronic identification number are transmitted in real time or after the fact to the central calculator 50, if necessary via the local calculator 5. The central calculator 50 then mathematically converts the exposure value L_{eq},s received into %dose,p and then adds it to the exposure account of the electronic identification number with which it is associated. If necessary, the central calculator 50 deducts from this exposure account a value of %recovery,p corresponding to the value of the period s transmitted.

The percentages %dose,p and %recovery,p are defined by the standards and regulations in force taking account of the length of the period p in question. Otherwise, these percentages are extrapolated from one another.

The central calculator 50 can mathematically convert the values L_{eq} transmitted into several %dose,p and %recovery,p the values p of which may be different, for example: one day, one week, one year, a professional career, etc.

Furthermore, the procedure according to the invention may also inform the individual of the physiological recovery periods necessary. For this, the method may comprise additional steps consisting in:
calculating the “Trecovery” period corresponding to the period of physiological recovery necessary to reduce the dose of noise “%dose,p” received by the individual during his sound exposure up to the level of a predetermined value, for example 0% or 50% of the weekly dose; for this, a local calculator 5 or a central calculator 50 integrates a known physiological recovery model;
emitting signals representing the result of this calculation of “Trecovery” period of physiological recovery; these results may then be displayed on an interface as explained above.

The emission of these results may be carried out at the request of the individual and/or at any preprogrammed time, that is to say predefined in the calculator for example in a regular manner, and/or when his sound exposure exceeds or reaches a given value, for example a normative threshold.

Thus, the individual knows the noise dose %dose,p which he has accumulated during his many stays in noisy locations, but also the recovery period that he will have to observe in order to reduce this dose to a value that he has chosen or that is predetermined, for example according to his next sound exposures that can be foreseen by the calculator because of their recurrence or of their possible planning.

In practice, the calculation of the necessary “Trecovery” physiological recovery period may for example be carried out as follows:

Trecovery (in seconds)=%dose,p/%recoveryPeriod/second, where %recoveryPeriod/second may be, depending on the adopted period, one of the variables %recoveryDay/second or %recoveryWeek/second illustrated by the table of FIG. 9.

According to a variant, the necessary “Trecovery” physiological recovery period may also be calculated as follows:

Trecovery (in seconds)=%dose,p. [Period p (in seconds)−(1/L_{eq})] where L_{eq} is the equivalent average sound level (in dB if necessary weighted A, B, C etc.) measured over the sliding period p that has just passed.

In addition, in order to provide yet more accurate results and because of the fact that the hearing of an individual recovers faster if his sound exposure is more fractioned, this calculation of recovery 2 period may be based on a model integrating the fractioned character of the sound exposure of the individual during his many stays in a noisy location or locations.

FIG. 9 shows a table having a calculation of daily doses and of weekly doses for different equivalent average sound levels ranging from 87 dB(A) to 114 dB(A). The doses are expressed as a percentage of the maximum admissible sound exposure, all being defined by the standards and regulations in force, for example ISO, European Directive and/or Labor Code.

FIG. 10 shows a table simulating the daily sound exposure of an individual carrying out many stays in noisy locations. The individual first goes to a workshop, between 8 am and midday, a workshop in which he is exposed for 4 hours, that is 14400 seconds, to noises emitted by machines. The individual is therefore exposed to an equivalent average sound level L_{eq} of 87 dB(A). Reduced to the second, this exposure corresponds to a noise dose of 0.0035% according to the standards and regulations, ISO, European Directive and/or Labor Code summarized in FIG. 9. During this first stay, the individual therefore receives 14400 times 0.0035%, that is to say 50.40% of the admissible daily dose.

Then, this individual leaves the workshop to take a lunch break for 1.5 hours. This break therefore constitutes a recovery period because it is taken in a not very noisy location. According to an extrapolation of the standards and regulations, ISO, European Directive and/or Labor Code summarized in FIG. 9, the individual therefore “recovers” 9.39% of the admissible daily dose.

From 1.30 pm to 5 pm, the individual returns to the workshop and receives 44.10% of the admissible daily dose. At the beginning of the evening, from 5.00 pm to 10 pm the individual is again in a recovery situation outside a noisy location. He then recovers 31.32% of the admissible daily dose.

From 10 pm to 10.45 pm, the individual goes to a concert hall where he is exposed to an equivalent average sound level L_{eq} of 99 dB(A), which corresponds to a dose of 0.0556% for 1 second and, over the period of 2700 seconds in question, to 150.12% of the admissible daily dose. Following the concert, the individual goes to a nearby discotheque where he is exposed from 10.45 to 11.30 pm to an equivalent average sound level of 99 dB(A), which also corresponds to 150.12% of the admissible daily dose. The individual then returns to his home where he rests from 11.30 pm to 8 am, a period during which he recovers 53.24% of the admissible daily dose.

In total, the sound exposure of this individual reaches 300.79% for the 24-hour day made up of these various stays in noisy locations and these physiological recovery periods. His sound exposure therefore corresponds to three times the admissible daily dose, so this individual risks suffering auditory problems. When the device or the method that are the subjects of the present invention are applied by equipping the workshop, the concert hall and the discotheque with a sensor 4 and a calculator 5 and associated peripheral devices while allocating the individual an identifier such as an RFID tag, the individual can be warned of the changes in the noise dose that he receives during his various stays and therefore limit or even eliminate the risks of auditory problems.

During this day, the individual may therefore be informed when his sound exposure, or, more precisely, the noise dose that he receives during his episodes of sound exposure, reaches or exceeds “on the way up” a given value, for example 80% of the admissible daily dose. In addition, by applying a method according to the invention, this individual may also be informed when his sound exposure reaches or exceeds “on the way down” another given value, for example 50% of the admissible daily dose.

A daily total may also be communicated to him every day, for example every day around 8 am, or every week, in order to help him to be aware of his exposure to noise. In addition, information on the physiological recovery period that he should observe in order to lower the noise dose that he has just received can be communicated to him. For example, he could be informed when he gets up, by a message on his cell phone that he should not expose himself again to high sound levels before 172868 seconds (300.79%/0.00174%), or 48 hours. This period corresponds to the period that his total exposure will take in order to drop to 0% of the admissible daily dose.

All this information allows the individual to know and manage his exposure and recovery levels in real time and/or in expectation of a new stay in a noisy location. Similarly, the information on the recovery period that he should observe in order to drop his noise dose may help him and his employer to plan his professional activities and his leisure activities during which he is likely to be exposed to high sound levels.

As indicated above, it is understood that the information on these sound exposure values may be supplemented by the number of times a maximum admissible peak pressure level value counted in a known manner is exceeded.

The methods and devices that are the subjects of the invention described with reference to FIGS. 1 to 8 are not limited to the evaluation of the sound exposure of a single individual, but on the contrary they make it possible to monitor several individuals simultaneously, to the extent that each one may be recognized and identified. Therefore, these devices make it possible to evaluate the sound exposures of all the employees operating in noisy industrial premises or of all the users and employees of a discotheque or of a concert hall, all of them being able furthermore to consist, in whole or in part, of the same persons. The invention therefore makes it possible to manage the risks of auditory problems associated with multiple and cumulative exposures of a large number of individuals over short or long periods.

The invention therefore makes it possible to free the individuals from wearing an apparatus of the dosimeter type that is cumbersome, costly and fragile, while supplying an accurate and reliable evaluation of their individual sound exposure. In addition, the invention considerably reduces the cost of this evaluation to the extent that it requires only one or a few sensor(s) for a large number of individuals.

On the installation of the device that is the subject of the invention, then in order to check regularly that it operates correctly, it is possible to carry out a calibration of the device by evaluating the sound exposures of individuals each equipped with a portable dosimeter and according to a standardized protocol. The comparison between the exposures evaluated by the device and those evaluated by the standardized dosimeters makes it possible to calibrate the device that is the object of the invention so that it transmits the most reliable and accurate data possible.

1-18. (canceled)

19. A device for evaluating the sound exposure of an individual spending time in at least one location exposed to the noise emitted by at least one source, wherein said device comprises:
at least one means for determining the moments of entry and of exit of the individual respectively into and out of the location;
at least one sensor installed in the location and capable of making noise measurements in at least one point of the location; and
a calculator capable, on the one hand, of communicating with the or each determination means and of defining the length of time spent by the individual in the location between the moments of entry and of exit and, on the other hand, of communicating with the or each sensor and of defining the values representative of the sound exposure of the individual during the time spent, the calculator being capable of emitting signals representative of this sound exposure.

20. The device as claimed in claim 19, wherein said device also comprises an interface capable of receiving the signals and of informing the individual of his sound exposure.

21. The device as claimed in claim 19, wherein the or each determination means comprises a member for recognizing the individual.

22. The device as claimed in claim 19, wherein the or each determination means comprises a member for recognizing an object worn by the individual.

23. The device as claimed in claim 22, wherein the or each determination means comprises an apparatus capable of detecting by radio identification a radio tag worn by the individual.

24. The device as claimed in claim 19, wherein the calculator is capable of communicating with means for locating the individual in real time in the location and of weighting the noise measurements according to the position of the individual relative to the sound source or sources.

25. The device as claimed in claim 24, wherein the location means comprise several items of apparatus spread out in the location and delimiting elementary spaces, the items of apparatus being capable of detecting the movements of the individual between the elementary spaces.

26. The device as claimed in claim 25, wherein said device comprises several sensors spread out in the location at the rate of at least one per elementary space, the calculator integrating the measurements made by the sensors installed in the elementary spaces consecutively traversed by the individual.

27. The device as claimed in claim 19, wherein said device comprises means for signaling to the calculator the use by the individual of an individual sound protection means, notably of the headphone or earplug type.

28. The device as claimed in claim 19, wherein said device also comprises a central calculator capable of communicating with the calculators installed in several locations and of totaling the sound exposures of the individual during consecutive or inconsecutive times spent in the various locations, the central calculator being capable of applying corrections according to the physiological recovery times separating the times spent and/or according to the medical antecedents of the individual.

29. The device as claimed in claim 28, wherein said device comprises means of communication, to the calculator or to the central calculator, of the sound exposure received by the individual when he is exposed to the sound emitted by an individual listening means, notably a personal stereo player fitted with a headphone or an earphone.

30. The device as claimed in claim 28, wherein said device comprises means of communication, to the calculator or to the central calculator, of the sound exposure measured by a personal dosimeter worn by the individual.

31. A method for evaluating the sound exposure of an individual spending time in at least one location exposed to the noise emitted by at least one source, wherein said method comprises steps consisting in:
a) making noise measurements in at least one point of the location by means of at least one sensor;
b) determining the moment of entry of the individual into the location;
c) communicating the moment of entry to a calculator;
d) communicating the noise measurements to the calculator;
e) integrating the noise measurements over the time spent by the individual in the location between the moments of entry and of exit by means of the sensor(s) or of the calculator;
f) determining the moment of exit of the individual from the location; and
g) emitting signals representative of the sound exposure of the individual during the time spent.

32. The method as claimed in claim 31, wherein the step g) precedes the step f).

33. The method as claimed in claim 31, wherein the step f) precedes the step g).

34. The method as claimed in claim 31, wherein said method also comprises the steps consisting in:
h) computing the physiological recovery time necessary to reduce the dose of noise received by the individual during his sound exposure to the level of a predetermined value; and
i) emitting signals representative of said physiological recovery time.

35. The method as claimed in claim 34, wherein said method also comprises a step j) consisting in transmitting the signals emitted during the step g) and/or during the step i) to an interface at the request of the individual and/or at any moment predefined in the calculator and/or when his sound exposure exceeds or reaches a predetermined value, notably as a function of a normative threshold.

36. The method as claimed in claim 31, wherein said method also comprises prior steps consisting in:
h) making noise measurements at several points spread out in the location and at a distance from the source;
i) defining a correction of the noise measurements received at each of the points; and steps consisting in:
J) locating the individual in real time in this location;
k) weighting values representative of the noise measurements of the sensor as a function of the corrections of the location.
